(19) United States
(12) Patent Application Publication
(10) Pub. No.: US 2006/0117543 A1
(43) Pub. Date: Jun. 8, 2006

(54) Method of rotary impact driving and apparatus

(75) Inventors: William Henry Ollis, Buckinghamshire (GB); David James Chadwick, Manchester (GB)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: Product Licensing Company Limited

(21) Appl. No.: 11/036,796

(22) Filed: Jan. 14, 2005

(30) Foreign Application Priority Data
Dec. 3, 2004 (GB) GB 0426581.5

(51) Int. Cl. B25B 21/02

(52) U.S. Cl. 29/428; 173/1

(57) ABSTRACT

A method of connecting two or more construction elements of a building structure using a profiled wire tie (7) comprising a core from which a plurality of loosely wound helical fins extend radially along its longitudinal axis and which is formed into a point (8) at each end. The method comprises the steps of: inserting a impact spindle (4) of a power driven adaptor (1) into the chuck of a rotary hammer drill; inserting the tie (7) sideways into an open longitudinal slot (3) in the side of the adaptor (1), which concentrically aligns the tie (7) with the impact spindle (4) and provides a means by which to steady the tie (7), when holding the handle (2); driving the tie (7) into the first construction element (9) whereby the action of the rotary hammer drill transmits and imparts, via the impact spindle (4), torsional impacts to the tie (7), which is driven via a series of helical thrusts (11), to cut a spiralling penetrative thread into the first construction element (9) and sequentially into the subsequent element(s) until the tie (7) is at least flush with the surface of the near construction element (9) and is seated at its desired penetrative depth within the subsequent element(s).

### BACKGROUND OF INVENTION

The technology of fixing helically profiled fasteners to connect together two or more construction elements has been commercially practised for the past 20 years.

Whilst in their simplest form the fasteners are used as hammer driven helical nails, one of the most common applications for the helical fastener is the reconnection of two or more masonry units whereby long slender versions of the fastener are utilised to re-tie two elements of a cavity wall structure. One end of the helical wall tie is loaded into a cylindrical insertion adaptor that has a central bore to provide means of confining the tie around its longitudinal axis and a drive pin. The tie is then driven into the wall, usually via a pre-drilled pilot hole, by axial impacts that are imparted by a reciprocating power tool to the tie along its longitudinal axis. Once initial penetration establishes sufficient bearing between the construction element and the tie, the deflecting reaction of the angular helix propels the tie helically, upon each axial impact, such that its work-hardened fins cuts a spiralling penetrative path as it is driven sequentially though the construction elements.

Whilst existing techniques and complex insertion adaptors provide satisfactory performance they are neither operator friendly or cost effective in terms of driving speed and down time.

The arrangement of an average rotary hammer drill connected with a cylindrical insertion adapter is in the region of 2foot long and weighs between 7-9 lb. The process of holding the drill with one hand and loading an average 9 inch long tie into a shallow borehole at the remote end of the adaptor with the other hand is itself cumbersome. The tie, having about 1 inch supported in the bore of the adaptor and 8 inches unsupported, naturally sits tilted and misaligned from the axis of the adaptor. The further unwieldy process of offering up and aligning the entire 32 inch long set up comprising drill, adaptor and tie, concentrically to an average ¼ inch pilot hole serves to compound handling difficulties and operator fatigue.

The configuration of such cylindrical tie-confining insertion adaptors is such that the drive pin/tie engagement is completely hidden from the eyes of the installing technician. The tie confining cylindrical adaptor rests against the wall during the part of the driving process when the drive pin moves moved forward within the cylinder and protrudes onward from it into the pilot hole to recess the tie at its pre-determined depth. It is often the case that at the point at which the tie leaves the cylinder and becomes unconfined, the drive pin, unseen by the technician, slips off of the tie, causing damage to the masonry surface. It is at the final stages of driving that the impacts between the adapter and the masonry causes a powdering of debris, which can contaminate the workings of the adaptor via the open leading end of the cylinder. Excessive tool wear and even jamming of the adaptors moving components may result from the ingress of such detritus, which is difficult to remove from the small bore of the cylindrical adaptor without it being fully stripped down for cleaning.

The use of torque free axial impacts results in energy loss such that the tie itself is required to initiate and maintain the necessary helically inclined energy path, which is created upon penetration by deflection of the fins upon a continuous frictional plane of abrasive masonry substrate.

Elaborate multi-part spring loaded adaptors are known to have been constructed to ensure that only axial impacts are imparted to the tie and that no torque is transmitted. Such elaborate multi-part spring loaded adaptors have cost and reliability issues.

The prior art of fixing a wire wall tie with helical fins extending radially from the core in order to helically reconnect two masonry construction units can be found in EP 0171250. The prior art relating to power driven cylindrical adaptors for driving helical wall ties can be found in U.S. Pat. No. 5,586,605 and its descendants.

EP 0171250 is pertinent in that it teaches and claims a method of manufacturing a wire helical wall tie (Claim 1) and a method of fixing such helical tie so as to tie together two bricks of a cavity wall by driving it axially through one brick into another whereby it grips on both sides of the cavity (Claim 9).

U.S. Pat. No. 5,586,605, and its descendants, is pertinent in that it teaches a multi-part spring-loaded insertion adaptor for use with a hammer drill for reciprocating driving a helical tie between parallel wall members.

The above prior art patents teach that a helical wall tie is inserted into an impact driven tool that has a bore to confine the tie around its longitudinal axis and which transmits axial impact forces to the longitudinal axis of the tie in the absence of any driven torque as the tie is driven.

### SUMMARY OF INVENTION

The invention finds significant utility in tying together two or more construction units such as may be required to reconnect parallel masonry units of a cavity wall structure or as may be required to reconnect a lower brick course of a failed arch to the masonry above or as may be required to connect two or more layers of timber or as may be required to connect timber to masonry. The tie connector utilised is a profiled and twisted wire comprising a core from which a plurality of loosely wound helical fins extend radially along its longitudinal axis and which is pointed at each end. The construction element may be drilled with a pilot hole that is larger than the core of the helical tie yet at least 1/16^{th} inch smaller than the circumscribed diameter measured around the periphery of the fins so that only the leading point of the tie can fit inside the mouth of the pilot hole. Alternatively, as may be the case with softwoods and aerated concrete, there may be no need for a pre-formed pilot hole. An installation adaptor is fitted into a standard rotary hammer drill and the tie is inserted via an open loading slot in the body of the adaptor. The adaptors impact spindle transmits the rotary hammer action of the drill directly to the tie around its longitudinal axis, each rotating hammer stroke providing sufficient beneficial driven torque and impact to propel the tie into a winding penetrative motion as the fins cut a helical path into the construction element. The tie is driven through the first element and sequentially into the subsequent unit(s) until the adaptors impact spindle positions the tie flush with or recessed below the face of the near element. The anchorage, in each element, is achieved by virtue of the peaks and troughs of the helix being interlocked within the helical passage cut by the fins during the driving process.

In view of the forgoing it is a principal object of the present invention to provide a method and apparatus for connecting construction elements with a wire helical tie using a rotary hammer drill driven helical tie insertion adaptor that is simple to load and operate, that facilitates easy access for cleaning and that provides a visual window for the operator to observe the adaptors working progress and the ties surface penetration throughout the entire driving process.

A further object of the present invention to provide a method and apparatus for connecting construction elements with a wire helical tie using an installation adaptor that utilises the rotary hammer action of a rotary hammer drill to transmit and impart impact driven torque circumferentially around the longitudinal axis of the tie, providing it with a torsional twisting bias to improve driving speed and mechanical efficiency.

Yet a further object of the present invention is to provide a method and apparatus for connecting construction elements with a wire helical tie using an installation adaptor that has just two main components and is constructed with select materials to optimise reliability and cost economics.

### BRIEF DESCRIPTION OF THE DRAWINGS

Further objects and advantages of the present invention will become apparent as the following description of an illustrative embodiment proceeds, taken in conjunction with the accompanying drawings, in which:

FIG. 1 is a longitudinal section of a helical tie insertion adaptor (1). The arrangement comprises a one-piece impact spindle (4) and a longitudinal handle (2) having a sideways loading slot (3) within the body of its forward portion and a cylindrical bore at the rear portion that houses the spindle (4) and a backstop ring ledge (6). The impact spindle (4) has means to move back and forth and rotationally within the confines of the handle (2) and, in its fully retracted position, the shoulder (12) of the spindle (4) will be positioned behind (to the right of) the backstop ring ledge (6).

FIG. 2 illustrates the sideways loading of a pointed helical tie (7), with a plurality of helically wound fins extending radially from its core, through the access slot (3) within the body of the forward portion of the handle (2). The tie (7), when loaded, sits upon the bottom cup of the slot (3), the width of which corresponds to the diameter of the tie (7), and is supported axially in line with the impact spindle (4)

FIG. 3 schematically illustrates the final position of the fastening arrangement when connecting two or more construction elements, in this example both elements being masonry, the tie (7) having been driven through one construction element (9) and subsequently into another, providing a helical interlocking connection at each. The rotary impacts of a rotary hammer drill energise the directly attached impact spindle (4), which in turn drives the tie (7) into the pre-drilled pilot hole (10). Once the handle (2) of the adaptor (1) reaches and rests against the first construction element (9), the impact spindle (4) is hammered forward in relation to the handle (2), its leading end travelling the length of the handles slotted portion (3) and beyond into the pilot hole (10) as the tie (7) is driven to its predetermined recessed depth. The slotted portion (3) of the handle (2) provides a visual window by which the operator is able to observe the progress of the entire driving procedure.

FIG. 4 illustrates the interaction between the impact spindle (4) and the helical tie (7) during the driving process.

FIG. 4A shows a pointed conical end (8) of a helical tie (7) being adjacent to a conical aperture (5) at the leading end of the impact spindle (4). The spindle (4) is rotating, as represented by the twisting arrows, and is disengaged from the tie (7) upon the backward stroke of the drills hammer action as represented by the dark arrow.

FIG. 4B shows the tie (7) and impact spindle (4) engagement upon the forward stroke of each rotary hammer impact, whereby the tip of the ties point (8) is positioned into a central relief bore (13) and the rotary hammer impact is delivered around and outside of the longitudinal axis of the tie (7). The helical angle of rotary hammer impact, shown by the twisting arrows around the impact spindle (4), delivers a torsional thrust, which closely correlates to the penetrative angle of the helix (11).

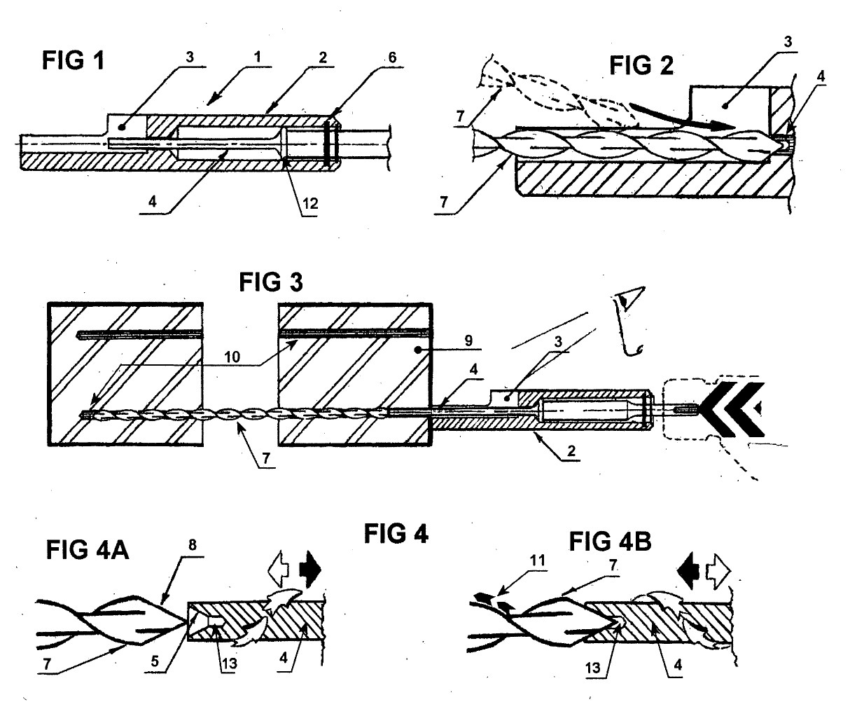

### DETAILED DESCRIPTION OF PREFERRED EMBODIMENT

The method for connecting construction elements with a wire helical tie (7) utilises an insertion adaptor (1) that has a one piece metal impact spindle (4) that has means at one end to engage directly into the chuck of a rotary hammer drill and that has at the other end a conical aperture (5) with a central relief bore (13) with means to engage with the conical point (8) at one end of the tie (7). The adaptor also has a one-piece synthetic longitudinal handle (2) having a cylindrical portion at one end, with a means of housing the forward section of the impact spindle (4) and an open slotted portion (3) at its forward end, with means to seat the helical tie (7). The tool is assembled so that the impact spindle (4) and can move back and forth and rotationally within the handle (2). The handle (2) has an internal backstop ring ledge (6), to support the impact spindle (4) in its fully retracted position. By utilising a synthetic handle (2) to house a traversable metal spindle (4) the need for lubrication, a dust-gathering constituent, within the adaptor (1) is alleviated.

With the forgoing description in mind the method of connecting construction elements with a wire helical tie (7) utilising an insertion adaptor (1) is reviewed as it addresses the first construction element; in this example, comprising an outer masonry unit (9), itself comprising a plurality of vertical members joined by mortar, an inner masonry unit and a cavity between the units; to install an average helical tie (7), for instance one with a 11/32 inch (9 mm) notional circumscribed diameter when measured around the periphery of the fins.

In this example a pilot hole (10) is formed through the first construction element and on to a pre determined depth in the subsequent element(s) using a drill bit with a diameter that is larger than the diameter of the ties core yet at least 1/16^{th} of an inch smaller than notional circumscribed diameter of the tie (7) when measured around the periphery of the fins.

The tie (7), which is pointed (8) at each end and comprises a plurality of loosely wound helical fins extending radially from its core and running along its longitudinal axis, is side loaded into the adaptor (1) via the longitudinal slot (3) within the body of the handle (2) whereupon it is seated upon the bottom cup of the slot (3) and is supported axially in line with the fully retracted impact spindle (4).

Side loading is beneficial in that it provides opportunity for the overall loading arrangement to be significantly shortened and provides a means by which to steady the tie (7), when holding the handle (2), as the overall installation arrangement as offered up to the wall to align concentrically with the pilot hole (10). The side-loading slot (3) provides easy access for cleaning out any detritus contamination collected during the installation process.

The impact spindle (4), energized by the rotary hammer drill into which it is directly connected, rotationally hammers and provides a series of torsional thrusts to the tie (7). It will be appreciated and understood that the tip of the ties point is, at each rotational impact, positioned in the counter-bore relief that is recessed within the spindles leading conical aperture (5). The conical engagement of the impact spindle and the tie therefore occurs circumferentially around and outside of the longitudinal axis of the tie (7), thus providing a positive twisting bias at each applied rotary impact.

Rotary hammer drills deliver rotary blows, the energy of which is directed into a helical path in the direction of chuck rotation. Typical hammer drills deliver five impacts blows, with ⅛^{th} inch strokes, per chuck rotation, the duration of each impact being less than 10% of the time taken for the drill to rotate the chuck through 360 degrees. The result delivers a maximum of 36 degrees of rotation per ⅛^{th} inch forward impact stroke. As a typical helical tie has a helical pitch of 5 times the notional circumscribed diameter per full pitch rotation, a typical 11/32^{nd} inch diameter tie has a nominal 1¾ inch pitch rotation. As such its twist over ⅛^{th} inch penetration is over 25 degrees. Such a close match of arced helical drive impact to that of the ties penetrative helical angle (11) provides that some 70% of the driven impact torque energy will be utilised. Such utilisation of driven impact torque provides tangible benefit in mechanical efficiency and installation speeds than is achievable by using torque free axial impacts alone.

At the first stage of driving, the tooling arrangement, comprising the rotary hammer drill and the insertion adaptor (1), moves towards the surface of the first construction element (9) as the high frequency torsional thrusts are orientated towards the ties penetrative helical passage as its fins cut into the walls of the pilot hole (10) in the first element (9) in accordance with the angle of the helix (11).

Once the adaptor reaches the surface of the first construction elements the impact spindle (4) breaks forward of the backstop ring ledge (6) and continues to drive the tie as it slides forwards along the cup of the slotted section (3) of the handle (2) and beyond, driving the tie (7) into the pilot hole in the subsequent construction element(s) until the tie (7) is driven to a predetermined depth whereupon it is flush with or recessed below the face of the near element (9). The slot provides a visual window by which the operator can observe penetration progress throughout the entire driving process permitting contact duration between the adaptor and the surface of the construction element to be kept to a minimum, thus alleviating possible surface damage.

Although particular embodiments of the invention have been shown and described in full here, there is no intension to thereby to limit the invention to the details of such embodiments. On the contrary, the invention is to cover all modifications, alternatives, embodiments, usages and equivalents as fall within the spirit and scope of the present invention, specifications and appended claims.

1. A method of connecting two or more construction elements of a building structure using a profiled wire tie (7) comprising a core from which a plurality of loosely wound helical fins extend radially along its longitudinal axis and which is formed into a point (8) at each end comprising the steps of:
inserting an impact spindle (4) of a power driven adaptor (1) into the chuck of a rotary hammer drill;
inserting the tie (7) sideways into an open longitudinal slot (3) in the side of the adaptor (1), which concentrically aligns the tie (7) with the impact spindle (4) and provides a means by which to steady the tie (7), when holding the handle (2);
driving the tie (7) into the first construction element (9) whereby the action of the rotary hammer drill transmits and imparts, via the impact spindle (4), torsional impacts to the tie (7), which is driven via a series of helical thrusts (11), to cut a spiralling penetrative thread into the first construction element (9) and sequentially into the subsequent element(s) until the tie (7) is at least flush with the surface of the near construction element (9) and is seated at its desired penetrative depth within the subsequent element(s).

2. A method according to claim 1, further comprising:
pre-drilling a pilot hole (10) through the near construction element (9) to a diameter larger than the core of the tie (7) yet less than the notional circumscribed diameter measured around the periphery of the ties fins.

3. A method according to claim 1, further comprising:
pre-drilling a pilot hole (10) to a pre-determined depth in the subsequent construction element (s) to a diameter larger than the core of the tie (7) yet less than the notional circumscribed diameter measured around the periphery of the ties fins.

4. A method according to claim 1, further comprising:
providing means to maximise the imparted torque at each delivered rotary impact by engaging the tip of one pointed end (8) of the tie in the counter-bore relief (13) that is recessed within the spindles leading conical aperture (5) thereby delivering the torsional impacts circumferentially around and outside of the centre axis of the tie (7).

5. A method according to claim 1, further comprising:
driving the tie (7) until the leading end of the impact spindle (4) protrudes forward and beyond the adaptors handle (2) and recesses the tie (7) below the surface of the near construction element (9).

6. A method of connecting two or more construction elements of a building structure using a profiled wire tie (7) comprising a core from which a plurality of loosely wound helical fins extend radially along its longitudinal axis and which is formed into a point (8) at each end comprising the steps of:
inserting a impact spindle (4) of a power driven adaptor (1) into the chuck of a rotary hammer drill;
inserting the tie (7) sideways into an open longitudinal slot (3) in the side of the adaptor (1), which concentrically aligns the tie (7) with the impact spindle (4) and provides a means by which to steady the tie (7), when holding the handle (2);
driving the tie (7) into the first construction element (9) whereby the action of the rotary hammer drill transmits and imparts, via the impact spindle (4), torsional impacts to the tie (7), which is driven via a series of helical thrusts (11), to cut a spiralling penetrative thread into the first construction element (9) and sequentially into the subsequent element(s) until the tie (7) is at least flush with the surface of the near construction element (9) and is seated at its desired penetrative depth within the subsequent element(s); and
wherein the tie is installed with an adaptor (1) that is energised by a rotary hammer drill and which comprises in combination:
a one-piece metal impact spindle (4) that has means at one end to engage directly into the chuck of a rotary hammer drill and that has at the other end a conical aperture (5) with means to engage with a pointed end (8) of a helical tie (7);
a one-piece synthetic longitudinal handle (2) having at one end a cylindrical portion with a means of housing the impact spindle (4) and that at its other end has an open slotted portion (3), with means to permit sideways loading of the helical tie (7) and means seat the tie (7) in axial alignment with the impact spindle (4);
a backstop ring ledge (6) with means to support the impact spindle (4) at its fully retracted position; and
the adaptor assembly (1) being such that the impact spindle (4) can move back and forth and rotationally within the confines of the handle (2).

7. A method according to claim 6, further comprising:
pre-drilling a pilot hole (10) through the near construction element (9) to a diameter larger than the core of the tie (7) yet less than the notional circumscribed diameter measured around the periphery of the ties fins.

8. A method according to claim 6, further comprising:
pre-drilling a pilot hole (10) to a pre-determined depth in the subsequent construction element (s) to a diameter larger than the core of the tie (7) yet less than the notional circumscribed diameter measured around the periphery of the ties fins.

9. A method according to claim 6, further comprising:
providing means to maximise the imparted torque at each delivered rotary impact by engaging the tip of one pointed end (8) of the tie in the counter-bore relief (13) that is recessed within the spindles leading conical aperture (5) thereby delivering the torsional impacts circumferentially around and outside of the centre axis of the tie (7).

10. A method according to claim 6, further comprising:
driving the tie (7) until the leading end of the impact spindle (4) protrudes forward and beyond the adaptors handle (2) and recesses the tie (7) below the surface of the near construction element (9).

11. A method according to claim 2, further comprising:
pre-drilling a pilot hole (10) to a pre-determined depth in the subsequent construction element (s) to a diameter larger than the core of the tie (7) yet less than the notional circumscribed diameter measured around the periphery of the ties fins.

12. A method according to claim 2, further comprising:
providing means to maximise the imparted torque at each delivered rotary impact by engaging the tip of one pointed end (8) of the tie in the counter-bore relief (13) that is recessed within the spindles leading conical aperture (5) thereby delivering the torsional impacts circumferentially around and outside of the centre axis of the tie (7).

13. A method according to claim 3, further comprising:
providing means to maximise the imparted torque at each delivered rotary impact by engaging the tip of one pointed end (8) of the tie in the counter-bore relief (13) that is recessed within the spindles leading conical aperture (5) thereby delivering the torsional impacts circumferentially around and outside of the centre axis of the tie (7).

14. A method according to claim 2, further comprising:
driving the tie (7) until the leading end of the impact spindle (4) protrudes forward and beyond the adaptors handle (2) and recesses the tie (7) below the surface of the near construction element (9).

15. A method according to claim 3, further comprising:
driving the tie (7) until the leading end of the impact spindle (4) protrudes forward and beyond the adaptors handle (2) and recesses the tie (7) below the surface of the near construction element (9).

16. A method according to claim 4, further comprising:
driving the tie (7) until the leading end of the impact spindle (4) protrudes forward and beyond the adaptors handle (2) and recesses the tie (7) below the surface of the near construction element (9).

17. A method according to claim 7, further comprising:
pre-drilling a pilot hole (10) to a pre-determined depth in the subsequent construction element (s) to a diameter larger than the core of the tie (7) yet less than the notional circumscribed diameter measured around the periphery of the ties fins.

18. A method according to claim 7, further comprising:
providing means to maximise the imparted torque at each delivered rotary impact by engaging the tip of one pointed end (8) of the tie in the counter-bore relief (13) that is recessed within the spindles leading conical aperture (5) thereby delivering the torsional impacts circumferentially around and outside of the centre axis of the tie (7).

19. A method according to claim 8, further comprising:
providing means to maximise the imparted torque at each delivered rotary impact by engaging the tip of one pointed end (8) of the tie in the counter-bore relief (13) that is recessed within the spindles leading conical aperture (5) thereby delivering the torsional impacts circumferentially around and outside of the centre axis of the tie (7).

20. A method according to claim 7, further comprising:
driving the tie (7) until the leading end of the impact spindle (4) protrudes forward and beyond the adaptors handle (2) and recesses the tie (7) below the surface of the near construction element (9).

21. A method according to claim 8, further comprising:
driving the tie (7) until the leading end of the impact spindle (4) protrudes forward and beyond the adaptors handle (2) and recesses the tie (7) below the surface of the near construction element (9).

22. A method according to claim 9, further comprising:
driving the tie (7) until the leading end of the impact spindle (4) protrudes forward and beyond the adaptors handle (2) and recesses the tie (7) below the surface of the near construction element (9).
